(19) United States
(12) Patent Application Publication
(10) Pub. No.: US 2011/0046859 A1
(43) Pub. Date: Feb. 24, 2011

(54) TRANSMISSION ACTUATOR DEVICE AND METHOD OF OPERATING THE TRANSMISSION ACTUATOR DEVICE

(75) Inventor: Thorsten Beyse, Schwieberdingen (DE)

Correspondence Address: CROWELL & MORING LLP;INTELLECTUAL PROPERTY GROUP, P.O. BOX 14300, WASHINGTON, DC, 20044-4300, US

(73) Assignee: Knorr-Bremse Systeme fuer Nutzfahrzeuge GmbH, Muenchen (DE)

(21) Appl. No.: 12/280,130

(22) PCT Filed: Feb. 22, 2006
(86) PCT No.: PCT/EP2007/001443

§ 371 Date: Dec. 19, 2008

(30) Foreign Application Priority Data
Feb. 22, 2006 (DE) 10 2006 008 575.2

(51) Int. Cl. F16H 61/26

(52) U.S. Cl. 701/51

(57) ABSTRACT

A transmission actuator device has a plurality of valves and a controller which is designed to actuate the plurality of valves. The transmission actuator devices includes an interface for a further controller which is primarily provided for actuating components other than the transmission actuator device, wherein at least a number of valves of the plurality of valves can be actuated by the further controller through of the interface.

### BACKGROUND AND SUMMARY OF THE INVENTION

The present invention relates to a transmission actuator device having a plurality of valves and having a controller which is designed to operate the plurality of valves. The invention also relates to a motor vehicle component, in particular a vehicle control computer, which is intended primarily for operating other components in a motor vehicle than a transmission actuator device, and to a system for operating a transmission actuator device, having a controller and having a further controller which is at least partially redundant with respect to the former. The invention also relates to a method for production of a fail-safe state in a transmission actuator device.

Both hydraulically and pneumatically operated transmission actuator devices are known, with the latter being used in particular in the commercial-vehicle sector. In this case, at least one controller which is associated with the transmission actuator device operates valves, in particular solenoid valves, such that pistons are moved to different positions by the respective pressure medium. The combination of the various piston positions results in a specific transmission ratio or a specific gear. Since the speed of the vehicle can be influenced via the transmission ratio, the controller for the transmission actuator device carries out a safety-relevant task. This is particularly true in situations in which the controller for the transmission actuator device not only provides open-loop or closed-loop control of the piston positions but also of the vehicle clutch, by which the power flow to the engine can be opened or closed. Because of the safety-relevant function of the controller of the transmission actuator device, it is necessary for a fail-safe state to be reached in the event of an electronic defect or an electronic failure.

In the case of hydraulically driven transmission actuator devices, it is possible in some cases for the fail-safe state in the event of an electronic defect or failure to be ensured by the hydraulic system. In these situations, there is no need for redundant electronic structures since an electronic failure does not lead to a safety-critical state.

In the case of pneumatically driven transmission actuator devices, the fail-safe state can generally not be achieved by the pneumatics alone. Particularly in conjunction with pneumatically driven transmission actuator devices, at least some electronic structures are thus provided in a redundant form.

FIG. 1 shows a transmission actuator device such as this equipped with redundant electronic structures, according to the prior art and in the form of a schematic block diagram illustration. The known transmission actuator device 10′ as illustrated in FIG. 1 includes a plurality of solenoid valves, of which only valves 12′ and 14′ are illustrated. The valves 12′, 14′ are operated by a controller 16′ and a further controller 18′, via an access monitoring device 26′. The controller 16′ is monitored by a watchdog 32′, that is to say a unit for monitoring the correct operation of a (micro) controller which, for this purpose, interchanges a signal 30′ with the controller 16′. If the watchdog 32′ comes to the conclusion that the controller 16′ is operating correctly, then it signals this to the access monitoring device 26′ via an enable signal 36′.

In a similar manner, the further controller 18′ is monitored by a further watchdog 18′ which, for this purpose, interchanges signals 24′ with the further controller 18′. If the further watchdog 18′ comes to the conclusion that the further controller 18′ is operating correctly, then it signals this to the access monitoring device 26′ via a further enable signal 38′. The controller 16′ and the further controller 18′ can interchange signals 40′ for this purpose, for example to match their modes of operation to one another or to interchange information which only one of the controllers 16′, 18′ receives. Furthermore, the first controller 16′ can interchange signals 44′ with the access monitoring device 26′, while the further controller 18′ can interchange signals 42′ with the access monitoring device 26′.

The controller 16′ and the further controller 18′ can, for example, use the signals 42′, 44′ to deduce the current state of the transmission actuator device. The controller 16′ produces an operating signal Op_A_MV_1′, which is intended for operating the valve 12′, and an operating signal Op_A_MV_2′, which is intended for operating the valve 14′. The further controller 18′ produces an operating signal Op_B_MV_1′, which is likewise intended for operating the valve 12′, and an operating signal Op_B_MV_2′, which is likewise intended for operating the valve 14′. When the watchdog 32′ and the watchdog 34′ apply the enable signals 36′, 38′, the access monitoring device 26′ uses the information available to it to carry out a plausibility check of the operating signals Op_A_MV_1′ and Op_B_MV_1′ and, respectively, Op_A_MV_2′ and Op_B_MV 2′ and passes a valve operating signal Op_MV_1′ to the valve 12′, and a valve operating signal Op_MV_2′ to the valve 14′ if the plausibility check has been successful. The controller 16′ and the further controller 18′ therefore form a redundant structure, which ensures a fail-safe state (or an emergency mode) can be reached even if the controller 16′ or the further controller 18′ fails entirely or partially.

Particularly when the controller 16′ and the further controller 18′ are arranged on a common board, faults are also possible with this solution, however, in which the controller 16′ and the controller 18′ fail at the same time, thus resulting in a safety-critical state. Furthermore, the provision of two redundant controllers is associated with high costs.

The invention is based on the object of specifying a safety concept for a transmission actuator device, which makes it possible to improve safety and reduce costs.

The transmission actuator device according to the invention provides an interface for a further controller, which is intended primarily for operating other components than the transmission actuator device, in which case at least some valves from the plurality of valves can be operated via the interface. In this solution, the redundancy which is required to reach the fail-safe state is produced by a further controller, which is intended primarily for operating components other than the transmission actuator device and which is provided in any case in the vehicle. In consequence, as only one controller is therefore physically associated with the transmission actuator device, and the further controller is located at a physical distance from the transmission actuator device, this reduces the number of potential faults in which both controllers fail at the same time (for example, failure of the common power supply, board fracture, etc.), and the safety is improved. This is particularly true when the two controllers are connected via different cable harnesses. Since, in comparison to the prior art, one controller can be omitted in the transmission actuator device according to the invention, this reduces the costs of the electronics. The printed circuit board or the hybrid can be made physically smaller, that is to say, it requires less space in the vehicle.

Preferred embodiments of the transmission actuator device according to the invention provide that the device can receive at least one signal via the interface, which signal indicates whether the further controller is operating correctly. In particular, this signal may be an enable signal, for example an enable signal which is produced by a watchdog associated with the further controller.

It is also preferable for the transmission actuator device according to the invention for at least some of the valves from the plurality of valves to be operated via an access monitoring device. In a similar manner to that in the case of the prior art, the access monitoring device can, in particular, carry out a plausibility check on the signals produced by the controller and the further controller.

In this context, it is also preferable for the controller to produce operating signals in order to operate the valves, for the further controller to produce further operating signals in order to operate the valves, and for the access monitoring device to be able to form valve operating signals on the basis of the signal, of the further signal, of the operating signals, and of the further operating signals. If the transmission actuator device according to the invention is a development of the prior art as explained in the introduction with reference to FIG. 1, this solution makes it possible for the interface to be created in a simple manner such that the lines which are connected to the further controller in the case of the prior art are passed to the exterior.

In one particularly preferred development of the transmission actuator device according to the invention, the further controller is a part of a motor vehicle component, in particular in the form of a vehicle control computer, or forms this component. For example, a vehicle control computer such as this is provided as standard, in particular in modern commercial vehicles, in which case it is possible with little effort to upgrade known vehicle control computers by adding the functionality which is required to implement the invention. In general, one idea which is significant for the invention is to use computation power which is available in the vehicle in any case as a substitute for the further controller. If required, the interface can carry out signal matching with regard to the signals coming from the vehicle control computer and the signals passed on to it, if this is necessary.

The motor vehicle component according to the invention is designed to operate at least some valves from a plurality of valves of the transmission actuator device, at least when a controller which is associated with the transmission actuator device cannot successfully operate at least one valve from the plurality of valves. By way of example, this solution can extend the functionality of a known vehicle control computer such that, in addition to its primary tasks, it can additionally carry out the task of the further controller which is provided in the transmission actuator device according to the prior art. This results in the characteristics and advantages explained in conjunction with the transmission actuator device according to the invention, in the same manner or a similar manner, for which reason reference is made to the corresponding statements, in order to avoid repetition.

The motor vehicle component according to the invention preferably has a motor vehicle component interface via which it can operate the at least some of the valves from the plurality of valves of the transmission actuator device. By way of example, this motor vehicle component interface may be formed by a bus, which is provided in any case, or an analog or digital interface, which must additionally be provided.

Furthermore, for the vehicle control computer according to the invention, it is preferable for the vehicle control computer interface to be designed to receive at least one signal which is produced by the transmission actuator device and by which the vehicle control computer can deduce states in the transmission actuator device. If the vehicle control computer can evaluate the same signals as the further controller that is provided according to the prior art, the transmission actuator device can be adapted with minimal effort to allow the invention to be implemented.

The system according to the invention for operation of a transmission actuator device physically associates the controller with the transmission actuator device, and the further controller is arranged physically at a distance from the transmission actuator device. In this context, the transmission actuator device is preferably a transmission actuator device according to the invention. The characteristics and advantages that have already been explained with reference to the transmission actuator device according to the invention also result for the purposes of the system according to the invention, for which reason reference is once again made to the corresponding statements, in order to avoid repetition.

Particular preferred embodiments of the system according to the invention provide that the further controller is a part of a motor vehicle component, in particular of a vehicle control computer, or forms this component. In this case, it is particularly preferable for the vehicle control computer to be a vehicle component according to the invention.

The method according to the invention for production of a fail-safe state in a transmission actuator device is distinguished in that the method includes one of the two following steps:
(a) at least some of the valves from a plurality of valves of the transmission actuator device are operated by a further controller, which is provided outside the transmission actuator device and is intended primarily for operating other components when a controller, which is associated with the transmission actuator device cannot successfully operate at least one valve from the plurality of valves, or
(b) at least some of the valves from a plurality of valves of the transmission actuator device are operated by a controller, which is physically associated with the transmission actuator device, when a further controller, which is provided outside the transmission actuator device and is intended primarily for operating other components, cannot successfully operate at least one valve from the plurality of valves.

In this case as well, the transmission actuator device is preferably a transmission actuator device according to the invention and the further controller is a vehicle component according to the invention in the form of a vehicle control computer. Reference is made once again to the advantages and characteristics which have already been cited a number of times above and explained on the basis of the transmission actuator device according to the invention, in order to avoid repetition.

### BRIEF DESCRIPTION OF TH DRAWINGS

The invention will now be explained, by way of example, on the basis of one preferred embodiment and with reference to the accompanying drawings, in which:

FIG. 1 is a schematic block diagram, as already explained initially, of a known transmission actuator device;

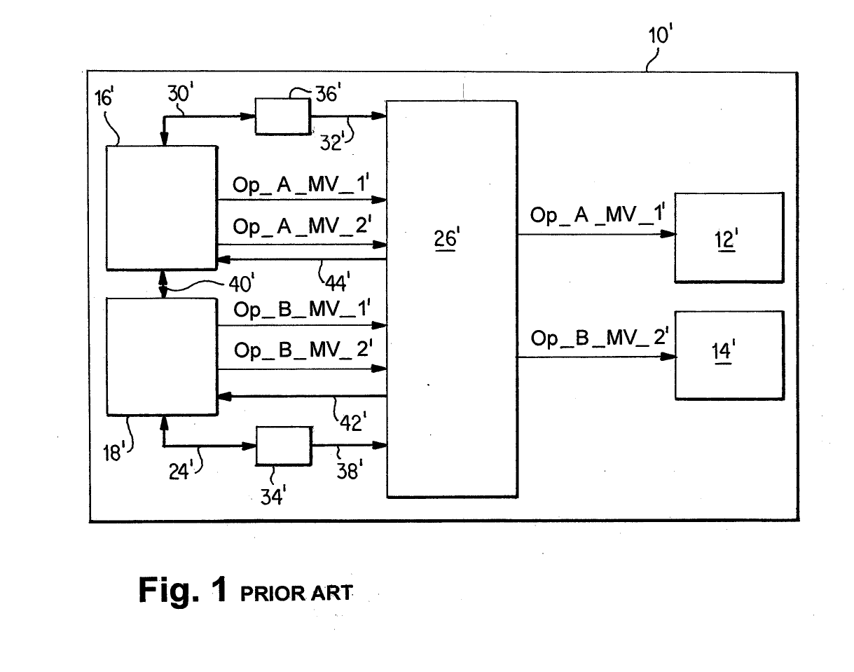

FIG. 2 is a schematic block diagram, which illustrates one embodiment of the transmission actuator device according to the invention, one embodiment of the vehicle control computer according to the invention, and one embodiment of the system according to the invention, with the device which is illustrated in the block diagram also being suitable for carrying out the method according to the invention.

### DETAILED DESCRIPTION OF THE DRAWINGS

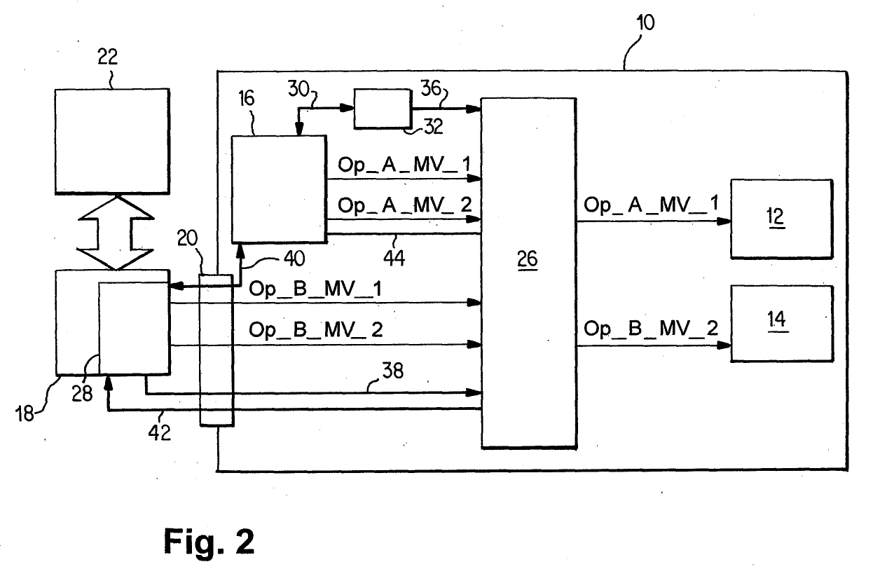

FIG. 2 illustrates one embodiment of the system according to the invention, which includes a transmission actuator device 10 according to the invention and a motor vehicle component according to the invention in the form of a vehicle control computer 18. The transmission actuator device 10 has a plurality of solenoid valves, of which only the valves 12 and 14 are illustrated by way of example. The valves 12 and 14 are operated via an access monitoring device 26, which receives signals from a controller 16, which is physically associated with the transmission actuator device 10, and from a further controller in the form of the vehicle control computer 18. The controller 16 is monitored by a watchdog 32, which for this purpose interchanges signals 30 with the controller 16. If the watchdog 32 comes to the conclusion that the controller 16 is operating correctly, it signals this to the access monitoring device 26 via an enable signal 36. Furthermore, the controller 16 can also interchange signals 44 directly with the access monitoring device 26.

In order to allow communication with the vehicle control computer, which is physically at a distance from the transmission actuator device, and the further controller 18, the transmission actuator device 10 has an interface 20. The vehicle control computer 18 is equipped with a vehicle control computer interface 28, for the same purpose. These interfaces 20, 28 are used to transmit the operating signals Op_B_MV_1 and Op_B_MV_2, which are associated with the valves 12, 14, an enable signal 38, which indicates whether the vehicle control computer 18 is correctly producing the operating signals Op_B_MV_1, Op_B_MV_2, which allow direct communication between the access monitoring device 26 and the vehicle control computer 18, and signals 40, which allow information to be interchanged between the controller 16 and the access monitoring device 26.

The vehicle control computer 18 is a component which is provided in any case in the vehicle and is intended primarily for operation of components 22 (for example, engine components) other than the transmission actuator device 10, but whose functionality is extended. In principle, the functionality of the further controller may, however, be formed according to the invention by any computation power which is provided independently of the transmission actuator device 10 in the vehicle. In the illustrated case, the functionality of the vehicle control computer 18 is extended in comparison to the prior art such that the vehicle control computer 18 can supply and process the signals which, in the case of the prior art, were supplied and processed by the further controller provided in the transmission actuator device.

During operation when there are no faults, the apparatus illustrated in FIG. 2 can operate, for example, as follows: the controller 16 produces a signal Op_A_MV_1 associated with the valve 12 and a signal Op_A_MV_2 associated with the valve 14, and passes these signals to the access monitoring device 26. The vehicle control computer 18 likewise produces a signal Op_B_MV _1 associated with the valve 12 and a signal Op_B_MV_2 associated with the valve 14, and likewise passes these signals to the access monitoring device 26. Furthermore, the watchdog 32 signals that the controller 16 is operating correctly. In addition, the vehicle control computer 18 or a further watchdog, which is associated with it but is not illustrated, produces a request signal 38 which signals the vehicle control computer 18 is producing the operating signals Op_B_MV_1, Op_B_MV_2 correctly. On the basis of the information available to it, the access monitoring device 26 carries out a plausibility check on the signals Op_A_MV_1 and Op_B_MV_1, as well as Op_A_MV_2 and Op_B_MV_2. If the plausibility check is successful, the valve 12 is operated in the desired manner by the valve operating signal Op_MV_1 and the valve 14 is operated in the desired manner by the valve operating signal Op_MV_2.

The system as illustrated in FIG. 2 allows the method according to the invention to be carried out as follows.

It is assumed that the controller 16 has failed and is therefore producing only a voltage of 0 volts as the signal Op_A_MV_1 and Op_A_MV_2. This is identified by the watchdog 32 and is signaled to the access monitoring device 26 by the lack of the enable signal 36. In this situation, during its plausibility check, assuming that this is carried out despite the lack of the enable signal 36, the access monitoring device 26 also finds that the signals produced by the controller 16 are continuously at 0 volts, in contrast to the signals produced by the vehicle control computer 18. In any case, the information that the controller 16 has failed is available to the access monitoring device 26. The access monitoring device 26 may still attempt to pass a signal 44 to the controller 16, by which signal 44 the controller 16 can normally deduce the state of the transmission actuator device 10, and then reacts appropriately. At the latest when an attempt such as this also remains unsuccessful, the access monitoring device 26 uses a signal 42, which is passed via the interface 20 and the interface 28, to inform the vehicle control computer 18 that the controller 16 has failed, and that the fail-safe state must be assumed. In response to this, the vehicle control computer 18 produces operating signals Op_B_MV_1 and Op_B_MV_2, which correspond to the fail-safe state, and are implemented by the access monitoring device 26, and/or are passed on as signals Op_MV_1 and Op_MV _2 and are implemented appropriately by the valves 12, 14. It is clear that the controller 16 can change the transmission actuator device 10 to the fail-safe state in an appropriate manner when the further controller 18 completely or partially fails in terms of operation of the valves 12, 14.

In particular, the operating signals Op _A_MV_1, Op_A_MV_2, Op_B_MV_1, Op_B_MV_2 (or at least some of these signals) which are produced by the controller and by the further controller may be digital signals with the states “logic 0” or “logic 1”. Furthermore and in particular, these signals may be digitally coded signals (for example n² states can be transmitted when n lines are used for coding). It is also possible in particular for the operating signals to be digital signals with a serial protocol (for example K-line or LIN). Furthermore and in particular, the operating signals under discussion may describe a bus system (for example an SPI or a CAN interface).

All of the controllers mentioned here may be microcontrollers or other electrical circuits with which a person skilled in the art will be familiar and which are suitable for production and/or processing of the respective signals. This also applies to the access monitoring device 26. The interfaces mentioned may be both digital and analog interfaces. In a corresponding manner, the signals that have been mentioned may be analog or digital (parallel or serial) signals.

The features of the invention as disclosed in the above description, in the drawings and in the claims may be significant to the implementation of the invention both individually and in any desired combination.

### Table of Reference Symbols

10′, 10 Transmission actuator device

12′, 12 Valve

14′, 14 Valve

16′, 16 Controller

18′, 18 Motor vehicle component/vehicle control computer/further controller

20 Interface

22 Other component(s)

24′, 24 Monitoring signal

26′, 26 Access monitoring device

28′, 28 Motor vehicle component interface

30′, 30 Monitoring signal

32′, 32 Watchdog

34′ Further watchdog

36′, 36 Enable signal

38′, 38 Further enable signal

40′, 40 Signal

42′, 42 Signal

44′, 44 Signal

1-11. (canceled)

12. A transmission actuator device, comprising:
a plurality of valves;
a controller operatively configured to operate the plurality of valves via operating signals; and
an interface of the transmission actuator device, said interface allowing a further controller intended primarily for operating components other than the transmission actuator device to operate at least some of the plurality of valves via further operating signals from the further controller;
wherein the transmission actuator device receives at least one further signal via the interface, said further signal indicating whether the further controller is operating correctly; and
wherein the transmission actuator device produces a further signal in addition to the operating signals, said further signal indicating whether the controller is operating correctly.

13. The transmission actuator device according to claim 12, further comprising an access monitoring device, wherein at least some of the plurality of valves are operated via the access monitoring device.

14. The transmission actuator device according to claim 13, wherein the access monitoring device forms valve operating signals based upon the further signal produced by the transmission actuator device, the further signal received via the interface, and the operating signals of the controller and the further operating signals of the further controller.

15. The transmission actuator device according to claim 12, wherein the further controller is a part of a motor vehicle component.

16. The transmission actuator device according to claim 15, wherein the motor vehicle component is a vehicle control computer.

17. A vehicle control computer operatively configured to primarily operate components in a motor vehicle other than a transmission actuator device having a plurality of valves, the vehicle control computer comprising:
an interface through which the vehicle control computer operates at least some valves from the plurality of valves of the transmission actuator device when a controller associated with the transmission actuator device fails to successfully operate at least one valve from the plurality of valves via operating signals;
wherein the vehicle control computer receives at least one signal produced by the transmission actuator device via the interface in addition to the operating signals, the vehicle control computer deducing a status of the transmission actuator device via the at least one signal.

18. A system for operating a transmission actuator device, comprising:
a first controller;
a second controller operatively configured to be at least partially redundant with respect to the first controller; and
wherein the first controller is physically associated with the transmission actuator device, and the second controller is arranged physically at a distance from the transmission actuator device.

19. The system according to claim 18, wherein the second controller forms a part of a motor vehicle component.

20. The system according to claim 18, wherein the second controller forms a part of a vehicle control computer.

21. A method for producing a fail-safe state in a transmission actuator device, the method comprising at least one of the following acts:
operating at least some valves from a plurality of valves of the transmission actuator device via a second controller provided physically at a distance from the transmission actuator device and intended primarily for operating other components than the plurality of valves, the operating of at least some of the valves occurring when a first controller physically associated with the transmission actuator device cannot successfully operate at least one valve; and
operating at least some valves from the plurality of valves of the transmission actuator device via the first controller physically associated with the transmission actuator device, when the second controller provided physically at a distance from the transmission actuator device cannot successfully operate at least one valve from the plurality of valves.
